(19) United States
(12) Patent Application Publication
(10) Pub. No.: US 2025/0122874 A1
(43) Pub. Date: Apr. 17, 2025

(54) SCROLL COMPRESSOR AND METHOD FOR PRODUCING ECCENTRIC BUSH NECESSARY FOR SCROLL COMPRESSOR

(71) Applicant: Hanon Systems, Daejeon (KR)

(72) Inventors: Seung Yong Hwang, Daejeon (KR); Ok Hyun Kim, Daejeon (KR); Se Young Song, Daejeon (KR)

(21) Appl. No.: 18/567,869

(22) PCT Filed: Oct. 28, 2022
(86) PCT No.: PCT/KR2022/016690

§ 371 Date: Dec. 7, 2023

(30) Foreign Application Priority Data
Nov. 1, 2021 (KR) 10-2021-0148122

(51) Int. Cl. F04C 18/02; F04C 29/00; F04C 29/02

(52) U.S. Cl. CPC F04C 18/0215; F04C 29/0057; F04C 29/02; F04C 2230/91; F05C 2225/04; F05C 2253/12

(57) ABSTRACT

A scroll compressor and a method for producing an eccentric bush necessary for the scroll compressor, and since the scroll compressor includes: a shaft rotated by a drive source; an eccentric bush having a recess, into which the shaft is inserted, and an eccentric portion eccentric to the shaft; an orbiting scroll performing an orbiting motion in cooperation with the eccentric portion; and a fixed scroll engaged with the orbiting scroll, and the eccentric bush is formed according to a method for producing the eccentric bush for the scroll compressor including steps of sintering, sizing, and forming a coating layer such that the eccentric bush includes pore apertures and a coating layer, accordingly, the manufacturing cost and weight may be reduced, and the durability may be improved.

### CROSS REFERENCE TO RELATED PATENT APPLICATIONS

This is a U.S. national phase patent application of PCT/KR2022/016690 filed Oct. 28, 2022 which claims the benefit of and priority to Korean Patent Application No. 10-2021-0148122, filed on Nov. 1, 2021, the entire contents of each of which are incorporated herein for all purposes by this reference.

### FIELD

The present disclosure relates to a scroll compressor and a method for producing an eccentric bush necessary for the scroll compressor, more particularly, a scroll compressor configured to compress a refrigerant by using a fixed scroll and an orbiting scroll performing an orbiting motion by an eccentric bush, and a method for producing the eccentric bush necessary for the scroll compressor.

### BACKGROUND

In general, a vehicle is provided with an air conditioning (A/C) device for indoor cooling and heating. Such an air conditioning device includes a compressor, as a component of a cooling system, which compresses a low-temperature low-pressure gaseous refrigerant introduced from an evaporator into a high-temperature high-pressure gaseous refrigerant and sends the compressed refrigerant to a condenser.

The compressors are classified into a reciprocating type in which a refrigerant is compressed according to the reciprocating action of a piston, and a rotary type in which compression is performed while a rotary motion is being performed. According to the transfer schemes of driving sources, the reciprocating type includes a crank type in which the transference is performed to a plurality of pistons by using a crank, a swash plate type in which the transference is performed to a rotating shaft having a swash plate mounted thereon, and the like. The rotary type includes a vane rotary type using a rotary shaft and a vane which rotate, a scroll type using an orbiting scroll and a fixed scroll.

A scroll compressor can achieve a relatively high compression ratio when compared with other types of compressor, and also a stable torque because strokes for absorption, compression, and discharge of the refrigerant are smoothly connected. Therefore, the scroll compressor is widely used for refrigerant compression in an air conditioning device and the like.

FIG. 1 is a perspective view illustrating a conventional scroll compressor, and FIG. 2 is a perspective view illustrating an eccentric bush of the scroll compressor of FIG. 1.

Referring to FIGS. 1 and 2, the conventional scroll compressor includes a drive source 100 generating a rotation force, a shaft 300 rotated by the drive source 100, an eccentric bush 400′ having a recess 410′, into which the shaft is inserted, and an eccentric portion 420′ eccentric to the shaft 300, an orbiting scroll 500′ performing an orbiting motion in cooperation with the eccentric portion 420′; and a fixed scroll 600 engaged with the orbiting scroll and forming a compression chamber.

Here, a ball bearing B is formed between the eccentric bush 400′ and the orbiting scroll 500′.

However, the conventional scroll compressor had a problem of an increased manufacturing cost. In particular, since the eccentric bush 400′ is formed by forging or molding process and then, cut to fit for a required size, the manufacturing cost of the eccentric bush 400′ is increased. In addition, since the ball bearing B is provided therewith, there was a problem in that the manufacturing cost of the scroll compressor was increased.

Further, because of the ball bearing B, a weight of a rotating body increased and the durability deteriorated.

### SUMMARY

Therefore, an object of the present disclosure is to provide a scroll compressor capable of reducing the manufacturing cost and a method for producing an eccentric bush necessary for the scroll compressor.

In addition, another object of the present disclosure is to provide a scroll compressor capable of reducing the weight and improving durability and a method for producing an eccentric bush necessary for the scroll compressor.

One embodiment is a scroll compressor, including: a shaft rotated by a drive source; an eccentric bush having a recess, into which the shaft is inserted, and an eccentric portion eccentric to the shaft; an orbiting scroll performing an orbiting motion in cooperation with the eccentric portion; and a fixed scroll engaged with the orbiting scroll, and the eccentric bush may include pore apertures.

The eccentric bush may further include a coating layer disposed on a surface of the eccentric portion to slide in direct contact with the orbiting scroll.

The coating layer may be formed of a solid lubricant.

The solid lubricant may be formed of polytetrafluoroethylene (PTFE).

The orbiting scroll may include: a plate-shaped orbiting scroll base plate, an orbiting scroll wrap protruding from one surface of the orbiting scroll base plate, and an annular boss portion protruding toward an opposite side of the orbiting scroll wrap from another surface of the orbiting scroll base plate and into which the eccentric portion is inserted, and the coating layer may be formed on an outer circumferential surface of the eccentric portion, which opposes an inner circumferential surface of the boss portion, and may be in contact with the inner circumferential surface of the boss portion.

The coating layer may be formed on an end surface of the eccentric portion, which opposes a basal surface of the boss portion.

The orbiting scroll may include an annular boss portion, into which the eccentric portion is inserted, an end surface of the eccentric portion may be spaced apart from a basal surface of the boss portion to form a gap between the end surface of the eccentric portion and the basal surface of the boss portion, and the eccentric portion may include a first oil groove formed to be engraved from an outer circumferential surface of the eccentric portion and communicating with the gap.

In the boss portion, a communicating hole penetrating the boss portion to communicate the gap with an outside of the boss portion may be formed.

The recess may include a second oil groove formed to be engraved from a surface of the recess, extending in a circumferential direction of the eccentric portion, and communicating with the first oil groove.

The recess may further include a third oil groove formed to be engraved from the surface of the recess, extending in a radial direction of the recess, and communicating with the second oil groove.

Another embodiment is a method for producing an eccentric bush required for a scroll compressor including a shaft rotated by a drive source; an eccentric bush having a recess, into which the shaft is inserted, and an eccentric portion eccentric to the shaft; an orbiting scroll performing an orbiting motion in cooperation with the eccentric portion; and a fixed scroll engaged with the orbiting scroll, including: mixing a power required for the eccentric bush of the scroll compressor, compacting the powder having undergone the mixing; sintering a shaped article having undergone the compacting; and sizing a sintered article having undergone the sintering by compressing the sintered article.

The compacting may be performed for a plurality of times.

A mold used in at least one among the compacting, the sintering, and the sizing may include a protrusion for gripping the eccentric portion of the eccentric bush.

The protrusion may extend in an axial direction of the eccentric portion.

The method may further include: forming a coating layer on the eccentric portion of the eccentric bush after the sizing.

In the scroll compressor and the method for producing an eccentric bush necessary for the scroll compressor, since the scroll compressor includes a shaft rotated by a drive source; an eccentric bush having a recess, into which the shaft is inserted, and an eccentric portion eccentric to the shaft; an orbiting scroll performing an orbiting motion in cooperation with the eccentric portion; and a fixed scroll engaged with the orbiting scroll, and the eccentric bush is formed by a method for producing the eccentric bush for the scroll compressor, which includes sintering and sizing steps, such that the eccentric bush includes pore apertures, the manufacturing cost thereof may be reduced.

In addition, the method for producing the eccentric bush further includes forming a coating layer, and the coating layer contactable with the orbiting scroll is formed on a surface of the eccentric portion, an additional bearing is not necessary between the eccentric portion and the orbiting scroll, thereby the weight of the rotating body can be reduced and the durability can be improved.

### BRIEF DESCRIPTION OF THE DRAWINGS

FIG. 1 is a cross-sectional view illustrating a conventional scroll compressor,

FIG. 2 is a perspective view illustrating an eccentric bush in the scroll compressor of FIG. 1,

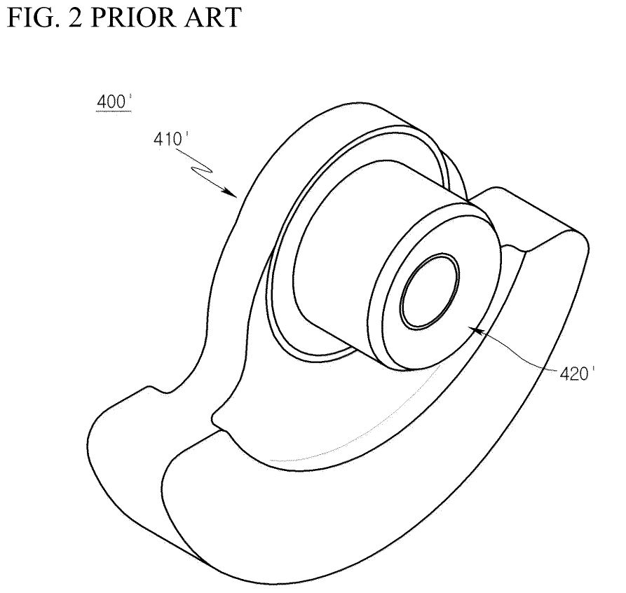

FIG. 3 is a cross-sectional view illustrating an assembled part of an eccentric bush and an orbiting scroll of a scroll compressor according to an embodiment of the present disclosure,

FIG. 4 is a perspective view of an eccentric bush of FIG. 3,

FIG. 5 is a front view of FIG. 4,

FIG. 6 is an enlarged view of part A of FIG. 3,

FIG. 7 is a flowchart illustrating a method for producing an eccentric bush of FIGS. 3 to 6, and

FIG. 8 is a front view illustrating an eccentric bush according to another embodiment of the present disclosure.

### DESCRIPTION OF AN EMBODIMENT

Hereinafter, a scroll compressor and a method for producing an eccentric bush necessary for the scroll compressor according to the present disclosure will be described in detail with reference to the accompanying drawings.

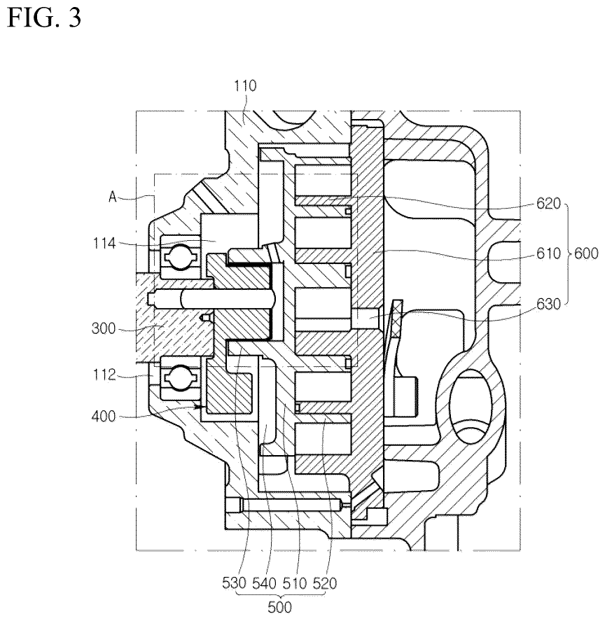

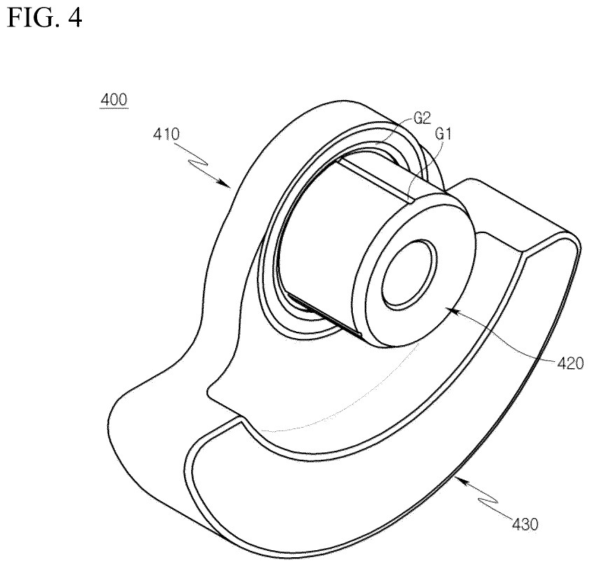

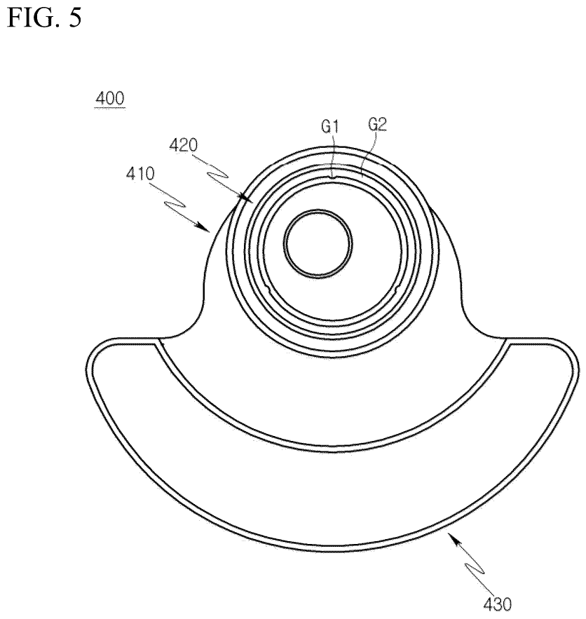

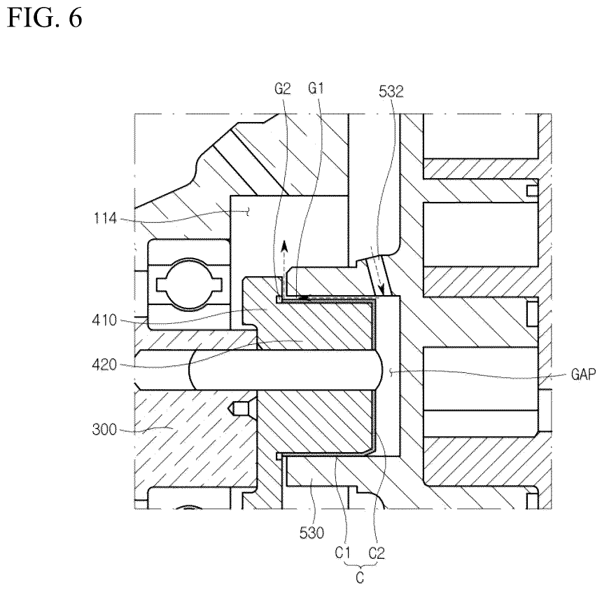

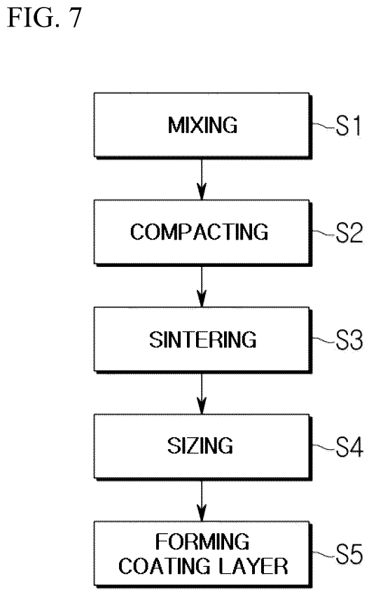

FIG. 3 is a cross-sectional view illustrating an assembled part of an eccentric bush and an orbiting scroll of a scroll compressor according to an embodiment of the present disclosure, FIG. 4 is a perspective view of an eccentric bush of FIG. 3, FIG. 5 is a front view of FIG. 4, FIG. 6 is an enlarged view of part A of FIG. 3, FIG. 7 is a flowchart illustrating a method for producing an eccentric bush of FIGS. 3 to 6.

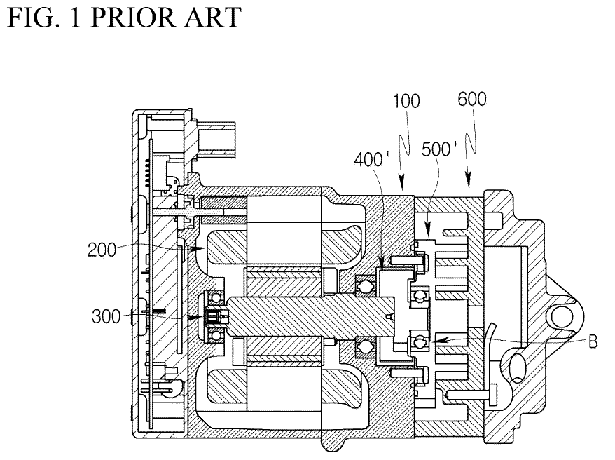

Meanwhile, FIG. 1 should be referred for components not illustrated in FIGS. 3 to 7 for convenience of description.

Referring to FIGS. 3 to 7 and FIG. 1, the scroll compressor according to an embodiment of the present disclosure may include a shaft 300 rotated by a drive source; a casing 100, a drive source 200 provided inside the casing and generating a rotation force, a shaft 300 rotated by the drive source 200, an eccentric bush 400 for converting the rotary motion of the shaft 300 into an eccentric rotary motion; an orbiting scroll 500 performing an orbiting motion in cooperation with the eccentric portion; and a fixed scroll 600 engaged with the orbiting scroll 500 and forming a compression chamber together with the orbiting scroll 500.

The casing 100 may include a main frame 110 that supports the orbiting scroll 500, and the main frame 110 may include a shaft receiving hole 112 into which the shaft 300 is inserted, and a back pressure chamber 114 which communicates with the shaft receiving hole 112 and into which the eccentric bush 400 is accommodated.

Here, the back pressure chamber 114 not only may compress the orbiting scroll 500 toward the fixed scroll 600 with a pressure of an oil filled in the back pressure chamber 114, but also may provide a space in which the eccentric bush 400 is rotated.

The drive source 200 may be formed as a motor having a stator and a rotor. Here, the drive source 200 may be formed as a disc hub assembly which is in communication with an engine of a vehicle.

The shaft 300 is formed as a cylindrical shape extending in one direction, and the shaft 300 may be coupled with the eccentric bush 400 at an end of the shaft 300, and coupled with the rotor at the other end thereof.

The eccentric bush 400 may include a recess 410 into which the shaft 300 is inserted, an eccentric portion 420 protruding in the opposite direction of the shaft 300 and is eccentric to the shaft 300 with respect to the recess 410, and a balance weight 430 disposed on the opposite side to the eccentric portion 420 with respect to the recess 410 so as to achieve an overall rotation balance of the eccentric bush 400.

In addition, the eccentric bush 400 may further include a coating layer C formed on a surface of the eccentric portion 420.

The coating layer C may be formed of a solid lubricant, such as polytetrafluoroethylene (PTFE), graphite, molybdenum disulfide (MoS2), and the like, for example.

In addition, the coating layer C may include a first coating portion C1 formed on an outer circumferential surface of the eccentric portion 420, and a second coating portion C2 formed on an end surface of the eccentric portion 420.

In addition, the eccentric bush 400 may further include a first oil groove G1 formed to be engraved from the outer circumferential surface of the eccentric portion 420.

The first oil groove G1 is provided in plural number, and each of the plurality of the first oil groove G1 may extend in an axial direction of the eccentric portion 420 and communicate with a gap GAP to be described later.

In addition, the eccentric bush 400 may further include a second oil groove G2 formed to be engraved from a surface of a portion of the recess 410 that meets the eccentric portion 420.

The second oil groove G2 may extend in a circumferential surface of the eccentric portion 420, and may be communicated with the plurality of first oil grooves G1.

Here, the coating layer C may be formed on a surface of the first oil groove G1, but in this case, since the coating layer C formed on the surface of the first oil groove G1 is formed to be engraved from the coating layer C formed on an outer circumferential surface of the eccentric portion 420, the first oil groove G1 is not fully filled with the coating layer C. That is, even if the coating layer C is formed, the first oil groove G1 may still effectively exist.

In the meantime, the eccentric bush 400 may be formed by a method for producing the eccentric bush according to an embodiment of the present disclosure, which includes steps of mixing S1, compacting S2, sintering S3, sizing S4, and forming the coating layer S5, as illustrated in FIG. 7.

In particular, a powder required for producing the eccentric bush 400 may be mixed. That is, the step of mixing S1 may be performed. Further, the powder mixed in the mixing S1 is compressed to be compacted to have a shape of the eccentric bush 400. That is, the compacting S2 may be performed. In addition, the shaped article having undergone the compacting S2 may be heated and the powder of the shaped article may be melted to attach so as to be sintered. That is, the sintering S3 may be performed. In addition, the shaped article having undergone the step of sintering S3 may be compressed so that a size thereof may be adjusted. That is, the sizing S4 may be performed. At this instance, the sizing S4 may be performed for multiple times in order to increase dimensional accuracy. In addition, an iron-based material including a region having 0.3 to 0.9% carbon content is used, a gravity of the shaped article that completed the compacting S4 for multiple times may be 7.0 g/cm3 or greater, a porosity of the finished article may be 7 to 15%, and a change of the porosity compared with a case applying a molding process may be 5% or lower. Further, the coating layer C may be formed in a certain portion (eccentric portion 420) of the shaped article that completed the compacting S4. That is, the forming the coating layer S5 may be performed.

Here, a mold (not illustrated) used in the compacting S2, the sintering S3, and the sizing S4 may include a protrusion for gripping a portion to be formed as the eccentric portion 420, and the protrusion may have a shape that corresponds to the first oil groove G1. That is, the protrusion may extend in an axial direction of the portion to be formed as the eccentric portion 420.

The orbiting scroll 500 may include a disk-shaped orbiting scroll base plate 510, an orbiting scroll wrap 520 protruding toward the fixed scroll 600 from one surface of the orbiting scroll base plate 510, and an annular boss portion 530 protruding toward the opposite side of the orbiting scroll wrap 520 from another surface of the orbiting scroll base plate 510 and into which the eccentric portion 420 is inserted.

Here, an anti-rotation member insertion groove 540 into which an anti-rotation member such as an Oldham ring, for example, may be further formed on another surface of the orbiting scroll base plate 510, and the anti-rotation member insertion groove 540 may communicate with and shield from the back pressure chamber 114, depending on a location of the orbiting scroll 500.

In addition, the boss portion 530 may include an inner circumferential surface opposed to the outer circumferential surface of the eccentric portion 420 and a basal surface opposed to an end surface of the eccentric portion 420, and the inner circumferential surface of the boss portion 530 may contact the outer circumferential surface of the eccentric portion 420 (more precisely, the first coating portion C1).

Meanwhile, the basal surface of the boss portion 530 may be spaced apart from the end surface of the eccentric portion 420 (more precisely, the second coating portion C2) so that a gap GAP is formed between the basal surface of the boss portion 530 and the end surface of the eccentric portion 420 (more precisely, the second coating portion C2).

Further, in the boss portion 530, a communicating hole 532 penetrating the boss portion 530 so as to communicate the gap GAP with an outside of the boss portion (more precisely, the anti-rotation member insertion groove 540) may be formed.

The fixed scroll 600 may include a disk-shaped fixed scroll base plate 610, a fixed scroll wrap 620 protruding from the fixed scroll base plate 610 and engaged with the orbiting scroll wrap 520, and a discharge outlet 630 penetrating the fixed scroll base plate 610 at center of the fixed scroll base plate 610.

Hereinafter, advantages of the scroll compressor according to an embodiment of the present disclosure, and the method for producing the eccentric bush necessary for the scroll compressor will be described.

That is, when the power is applied to the drive source 200, the shaft 300 may be rotated along with the rotor. Then, a series of processes may be repeated, where the orbiting scroll 500 performs an orbiting motion in cooperation with the shaft 300 through the eccentric bush 400, and the refrigerant is sucked into the compression chamber by the orbiting motion of the orbiting scroll 500, compressed in the compression chamber, and discharged from the compression chamber.

Here, with regard to the scroll compressor according to the present disclosure, since the eccentric bush is formed by the method for producing the eccentric bush for the scroll compressor according to the present disclosure which includes the sintering S3 and the sizing S4, the conventional cutting process may be omitted. Accordingly, processing costs and overhead costs required for adjusting a dimension of the eccentric bush 400 are reduced, thereby the manufacturing cost of the eccentric bush 400 may be reduced.

Further, since the eccentric bush 400 is formed by the sintering, the eccentric bush 400 may include pore apertures. Consequently, the material cost of the eccentric bush 400 may be reduced. In addition, the weight of the eccentric bush 400 may be decreased. Accordingly, the rotational inertia of the eccentric bush 400 is reduced, and the durability of parts supporting the rotating body may be improved. Moreover, the fuel efficiency of a vehicle to which the scroll compressor is mounted may be improved.

In addition, a pore aperture disposed on a surface of the eccentric bush 420 among the pore apertures increases the surface area of the eccentric portion 420, resulting in an increased bonding strength between the coating layer C and the eccentric portion 420.

Moreover, since the eccentric portion 420 includes the coating layer C, a ball bearing B which used to support the conventional eccentric portion 420 and the orbiting scroll 500 may be deleted. Accordingly, the number of parts, the weight and the manufacturing costs of the scroll compressor may be reduced. Also, since a diameter of the boss portion 530 may be reduced to a size of a diameter of the eccentric portion 420, the weight and the rotational inertia of the orbiting scroll 500 may be reduced and the durability of parts supporting the rotating body may be further improved.

In addition, since the coating layer C is formed as a solid lubricant layer, the damage between the eccentric portion 420 and the boss portion 530 may be suppressed.

Further, as like the arrows illustrated in FIG. 6, the oil in the back pressure chamber 114 is supplied between the outer circumferential surface of the eccentric portion 420 and the inner circumferential surface of the boss portion 530 through the anti-rotation member insertion groove 540, the communicating hole 532, the gap GAP and the first oil groove G1, the damage of the coating layer C and the damage between the eccentric portion 420 and the boss portion 530 may be suppressed.

Furthermore, since the oil that lubricated between the outer circumferential surface of the eccentric portion 420 and the inner circumferential surface of the boss portion 530 is collected at the second oil groove G2, and withdrawn to the back pressure chamber 114 through a split between the recess 410 and the boss portion 520, a fresh oil may be continuously supplied between the eccentric portion 420 and the boss portion 530.

In addition, since the gap GAP and the second oil groove serve to store the oil, it is possible to prevent the oil supply between the eccentric portion 420 and the boss portion 530 from being discontinued.

In addition, the coating layer C is provided not only to the outer circumferential surface of the eccentric portion 420, but also to the end surface of the eccentric portion 420, that is, not only to the first coating portion C1, but also to the second coating portion C2, and therefore, even if the end surface of the eccentric portion 420 comes into contact with the basal surface of the boss portion 530 by an abnormal behavior, the damage to the eccentric portion 420 and the boss portion 530 may be suppressed.

Further, since the mold (not illustrated) used in the compacting S2, the sintering S3, and the sizing S4 includes the protrusion for gripping the eccentric portion 420, and forms the first oil groove G1 while preventing a twist in an upper portion and lower portion of the mold (not illustrated) by means of the protrusion, the manufacturing defects of the eccentric bush 400 may be prevented and the manufacturing cost of the eccentric bush 400 may be reduced.

Moreover, the second oil groove G2 accommodates a burr of the mold (not illustrated), the second oil groove G2 may serve to prevent the mold (not illustrated) from twisting.

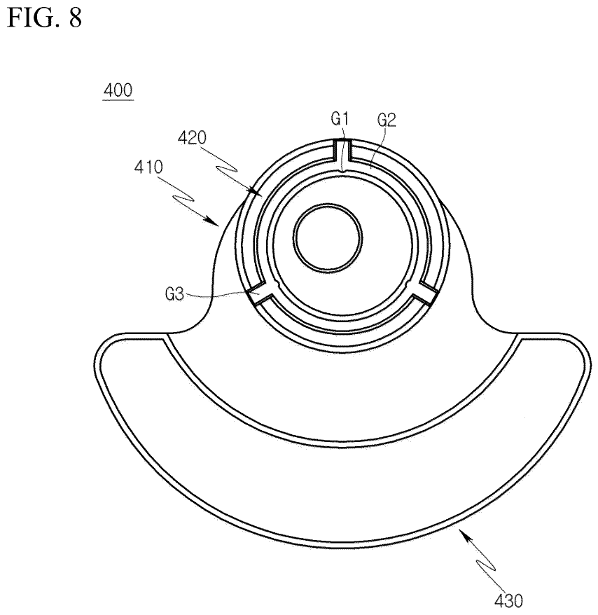

Meanwhile, in a case of the present embodiment, the first oil groove G1 and the second oil groove G2 are formed in the eccentric portion 420, but are not limited thereto. That is, only the first oil groove G1 may be formed in the eccentric portion 420. Alternatively, as illustrated in FIG. 8, a third oil groove G3 may be further formed in the eccentric portion 420 for the purpose of discharging the oil of the second oil groove G2 smoothly to the back pressure chamber 114. The third oil groove G3 may be formed to be engraved from a surface of the recess 410, extend in a radial direction of the recess 410, and communicate with the second oil groove G2. In addition, the third oil groove G3 may be formed in plural number, and the plurality of third oil grooves G3 may be radially disposed in a circumferential direction.

In the meantime, in the case of the present disclosure, the protrusion is formed in the entire molds (not illustrated) which are used in the compacting S2, the sintering S3, and the sizing S4, but is not limited thereto. That is, the protrusion may be formed in a mold (not illustrated) which is used in at least one among the compacting S2, the sintering S3, and the sizing S4.

1-15. (canceled)

16. A scroll compressor comprising:
a shaft rotated by a drive source;
an eccentric bush having a recess, into which the shaft is inserted, and an eccentric portion eccentric to the shaft;
an orbiting scroll performing an orbiting motion in cooperation with the eccentric portion; and
a fixed scroll engaged with the orbiting scroll, wherein the eccentric bush further comprises pore apertures.

17. The scroll compressor of claim 16, wherein the eccentric bush further comprises a coating layer disposed on a surface of the eccentric portion to slide in direct contact with the orbiting scroll.

18. The scroll compressor of claim 17, wherein the coating layer is formed of a solid lubricant.

19. The scroll compressor of claim 18, wherein the solid lubricant is formed of polytetrafluoroethylene (PTFE).

20. The scroll compressor of claim 17, wherein the orbiting scroll comprises a plate-shaped orbiting scroll base plate, an orbiting scroll wrap protruding from one surface of the orbiting scroll base plate, and an annular boss portion protruding toward an opposite side of the orbiting scroll wrap from another surface of the orbiting scroll base plate and into which the eccentric portion is inserted, wherein the coating layer is formed on an outer circumferential surface of the eccentric portion, which opposes an inner circumferential surface of the boss portion, and is in contact with the inner circumferential surface of the boss portion.

21. The scroll compressor of claim 20, wherein the coating layer is formed on an end surface of the eccentric portion, which opposes a basal surface of the boss portion.

22. The scroll compressor of claim 16, wherein the orbiting scroll further comprises an annular boss portion, into which the eccentric portion is inserted, wherein an end surface of the eccentric portion is spaced apart from a basal surface of the boss portion to form a gap between the end surface of the eccentric portion and the basal surface of the boss portion, and wherein the eccentric portion further comprises a first oil groove formed to be engraved from an outer circumferential surface of the eccentric portion and communicating with the gap.

23. The scroll compressor of claim 22, wherein in the boss portion, a communicating hole penetrating the boss portion to communicate the gap with an outside of the boss portion is formed.

24. The scroll compressor of claim 22, wherein the recess further comprises a second oil groove formed to be engraved from a surface of the recess, extending in a circumferential direction of the eccentric portion, and communicating with the first oil groove.

25. The scroll compressor of claim 24, wherein the recess further comprises a third oil groove formed to be engraved from the surface of the recess, extending in a radial direction of the recess, and communicating with the second oil groove.

26. A method for producing an eccentric bush required for a scroll compressor comprising a shaft rotated by a drive source; an eccentric bush having a recess, into which the shaft is inserted, and an eccentric portion eccentric to the shaft; an orbiting scroll performing an orbiting motion in cooperation with the eccentric portion; and a fixed scroll engaged with the orbiting scroll, the method comprising steps of:
mixing a powder required for the eccentric bush of the scroll compressor,
compacting the powder having undergone the mixing;
sintering a shaped article having undergone the compacting; and
sizing a sintered article having undergone the sintering by compressing the sintered article.

27. The method of claim 26, wherein the compacting is performed a plurality of times.

28. The method of claim 26, wherein a mold used in at least one among the compacting, the sintering, and the sizing comprises a protrusion for gripping the eccentric portion of the eccentric bush.

29. The method of claim 28, wherein the protrusion extends in an axial direction of the eccentric portion.

30. The method of claim 26, further comprising forming a coating layer on the eccentric portion of the eccentric bush after the sizing.
